(19) United States
(12) Patent Application Publication
(10) Pub. No.: US 2010/0288069 A1
(43) Pub. Date: Nov. 18, 2010

(54) STEERING COLUMN APPARATUS FOR VEHICLE

(75) Inventor: Kenji Imamura, Kosai-shi (JP)

Correspondence Address: OLIFF & BERRIDGE, PLC, P.O. BOX 320850, ALEXANDRIA, VA, 22320-4850, US

(73) Assignee: Toyota Jidosha Kabushiki Kaisha, toyota-shi (JP)

(21) Appl. No.: 12/450,463

(22) PCT Filed: Nov. 11, 2008
(86) PCT No.: PCT/IB2008/003032

§ 371 Date: Sep. 28, 2009

(30) Foreign Application Priority Data
Nov. 14, 2007 (JP) 2007-295403

(51) Int. Cl. B62D 1/187

(52) U.S. Cl. 74/493

(57) ABSTRACT

A steering column (SC) includes a lower tube (22) connected to a portion of a vehicle body through a housing (41) of a power steering actuator (40), and an upper tube (21) which is connected to the lower tube (22) to be slidable in a column axis direction, which is telescopic, and which is connected to the portion of the vehicle body through a bracket. The housing (41) is tiltable upward/downward with respect to the portion of the vehicle body. A rear end portion (41a) of the housing (41) is integrated with a lower end portion of the lower tube (22). The upper tube (21) is moved toward a front side of a vehicle with respect to the portion of the vehicle body, when a load equal to or above a predetermined value is applied to the upper tube (21). A reinforcement portion (51) is provided only in a bottom portion of an area where the rear end portion (41a) is integrated with the lower end portion.

### BACKGROUND OF THE INVENTION

1. Field of the Invention

The invention relates to a steering column apparatus for a vehicle. More specifically, the invention relates to a steering column apparatus for a vehicle, which includes a steering column that holds a steering wheel in a manner such that the steering wheel is rotatable, the steering column including a lower tube connected to a portion of a vehicle body through a housing of a power steering actuator; and an upper tube which is connected to the lower tube to be slidable in a direction of an axis of the steering column, which is telescopic, and which is connected to the portion of the vehicle body through a bracket.

2. Description of the Related Art

For example Japanese Patent Application Publication No. 2006-36077 (JP-A-2006-36077) describes the steering column apparatus for a vehicle, which has the above-described configuration. In the steering column apparatus for a vehicle described in the publication No. 2006-36077, the housing is tiltable in upward and downward directions with respect to the portion of the vehicle body; a rear end portion of the housing is integrated with a lower end portion of the lower tube by fitting the rear end portion of the housing into the lower end portion of the lower tube; and the upper tube is moved toward a front side of the vehicle with respect to the portion of the vehicle body, when a load equal to or above a predetermined value is applied to the upper tube.

In the steering column apparatus for a vehicle described in the publication No. 2006-36077, a bending moment occurs in a fitting portion where the rear end portion of the housing is fitted into the lower end portion of the lower tube, due to the load (secondary collision load) toward the front side of the vehicle, which is applied to an upper end portion of the steering column from an occupant. Therefore, the rear end portion of the housing pivots downward around a tilt center of the housing, and the lower end portion of the lower tube pivots downward so that the lower end portion of the lower tube is disconnected from the rear end portion of the housing. As a result, the lower end portion of the lower tube may be broken or disconnected from the rear end portion of the housing. Accordingly, the upper tube may not be appropriately moved in a direction of an axis of the steering column.

### SUMMARY OF THE INVENTION

An aspect of the invention relates to a steering column apparatus for a vehicle, which includes a steering column that holds a steering wheel in a manner such that the steering wheel is rotatable. The steering column includes: a housing of a power steering actuator, which is tiltable in upward and downward directions with respect to a portion of a vehicle body; a lower tube connected to the portion of the vehicle body through the housing, wherein a rear end portion of the housing in a longitudinal direction of a vehicle is integrated with a lower end portion of the lower tube; an upper tube connected to the lower tube to be slidable in a direction of an axis of the steering column, wherein the upper tube is telescopic, the upper tube is connected to the portion of the vehicle body through a bracket, and the upper tube is moved toward a front side of the vehicle with respect to the portion of the vehicle body when a load equal to or above a predetermined value is applied to the upper tube; and a reinforcement portion provided only in a bottom portion of an area where the rear end portion of the housing is integrated with the lower end portion of the lower tube.

In this aspect, the rear end portion of the housing may be integrated with the lower end portion of the lower tube by fitting the rear end portion of the housing to the lower end portion of the lower tube; and the reinforcement portion may restrict movement of the rear end portion of the housing and the lower end portion of the lower tube away from each other. Also, the rear end portion of the housing may be integrated with the lower end portion of the lower tube by integrally forming the housing and the lower tube; and the reinforcement portion may be configured using a reinforcement rib that extends in the direction of the axis of the steering column. In this case, a distance between an upper end of the reinforcement rib and a lower end of the upper tube may be equal to or longer than a predetermined distance so that the upper tube is movable the predetermined distance. Also, the rear end portion of the housing may be integrated with the lower end portion of the lower tube by integrally forming the housing and the lower tube; and the reinforcement portion may be formed by forming an inner hole of the lower tube in a manner such that a center of the inner hole is offset upward from an axis of the lower tube by a predetermined amount in a direction perpendicular to the axis of the lower tube.

In the above-described aspect, the rear end portion of the housing may be integrated with the lower end portion of the lower tube by fitting the rear end portion of the housing into the lower end portion of the lower tube; and the reinforcement portion may be configured using a screw. The rear end portion of the housing may be integrated with the lower end portion of the lower tube by fitting the lower end portion of the lower tube into the rear end portion of the housing; and the reinforcement portion may be configured using a screw.

The rear end portion of the housing may be integrated with the lower end portion of the lower tube by fitting the rear end portion of the housing into the lower end portion of the lower tube; and the reinforcement portion may be configured using a hook formed in a bottom portion of the lower end portion of the lower tube, and the hook may be pressed into an engagement hole formed in the rear end portion of the housing.

The steering column apparatus may further include a retention ring removably fitted to an outer periphery of the lower end portion of the lower tube; the rear end portion of the housing may be integrated with the lower end portion of the lower tube by fitting the rear end portion of the housing into the lower end portion of the lower tube;

the reinforcement portion may be configured using a pin that is integrally formed in a lower portion of the retention ring, and the pin may be fitted into a through-hole formed in a bottom portion of the lower end portion of the lower tube, and a through-hole formed in a bottom portion of the rear end portion of the housing. The retention ring may include a lower semicircular ring, an upper semicircular ring, and a pair of bolts that connects the lower semicircular ring to the upper semicircular ring; and the pin may be integrally formed in the lower semicircular ring.

In the steering column apparatus for a vehicle according to the invention, the reinforcement portion is provided only in the bottom portion of the area where the rear end portion of the housing is integrated with the lower end portion of the lower tube. The portion where the reinforcement portion is provided (i.e., the bottom portion of the above-described area) is pulled due to a bending moment, and is more likely to be displaced and deformed than a top portion of the above-described area (i.e., the portion compressed due to the bending moment). Accordingly, in the invention, displacement and deformation due to the bending moment are made less likely to occur by the reinforcement portion, and the weight is reduced as compared to the case where the entire area is reinforced. As a result, it is possible to effectively suppress the displacement and deformation of the lower end portion of the lower tube. Thus, the upper tube is appropriately moved in the direction of the axis of the steering column with respect to the lower tube.

Another aspect of the invention relates to a steering column apparatus for a vehicle, which includes a steering column that holds a steering wheel in a manner such that the steering wheel is rotatable. The steering column includes: a housing of a power steering actuator, which is tiltable in upward and downward directions with respect to a portion of a vehicle body; a lower tube connected to the portion of the vehicle body through the housing, wherein a rear end portion of the housing in a longitudinal direction of a vehicle is integrated with a lower end portion of the lower tube; an upper tube connected to the lower tube to be slidable in a direction of an axis of the steering column, wherein the upper tube is telescopic, the upper tube is connected to the portion of the vehicle body through a bracket, and the upper tube is moved toward a front side of the vehicle with respect to the portion of the vehicle body when a load equal to or above a predetermined value is applied to the upper tube; and a reinforcement portion provided in a bottom portion of an area where the rear end portion of the housing is integrated with the lower end portion of the lower tube.

### BRIEF DESCRIPTION OF THE DRAWINGS

The foregoing and further objects, features and advantages of the invention will become apparent from the following description of example embodiments with reference to the accompanying drawings, wherein like numerals are used to represent like elements and wherein:

FIG. 1 is a side view showing a steering column apparatus for a vehicle according to a first embodiment of the invention;

FIG. 2 is a longitudinal sectional side view showing a main portion of the steering column apparatus for a vehicle shown in FIG. 1;

FIG. 3 is a partially broken sectional view showing a rear end portion of a housing and a lower end portion of a lower tube, which are shown in FIG. 1 and FIG. 2;

FIG. 4A is a longitudinal sectional side view showing a main portion of a steering column apparatus for a vehicle according to a second embodiment of the invention, and FIG. 4B is a bottom view showing the main portion of the steering column apparatus for a vehicle according to the second embodiment of the invention;

FIG. 5A is a longitudinal sectional side view showing a main portion of a steering column apparatus for a vehicle according to a third embodiment of the invention, and FIG. 5B is an exploded perspective view showing a retention ring in the steering column apparatus for a vehicle according to the third embodiment;

FIG. 6A is a longitudinal sectional side view showing a main portion of a steering column apparatus for a vehicle according to a fourth embodiment of the invention, and FIG. 6B is a perspective view showing the main portion of the steering column apparatus for a vehicle according to the fourth embodiment of the invention; and

FIG. 7 is a perspective view showing a main portion of a steering column apparatus for a vehicle according to a fifth embodiment of the invention.

### DETAILED DESCRIPTION OF EMBODIMENTS

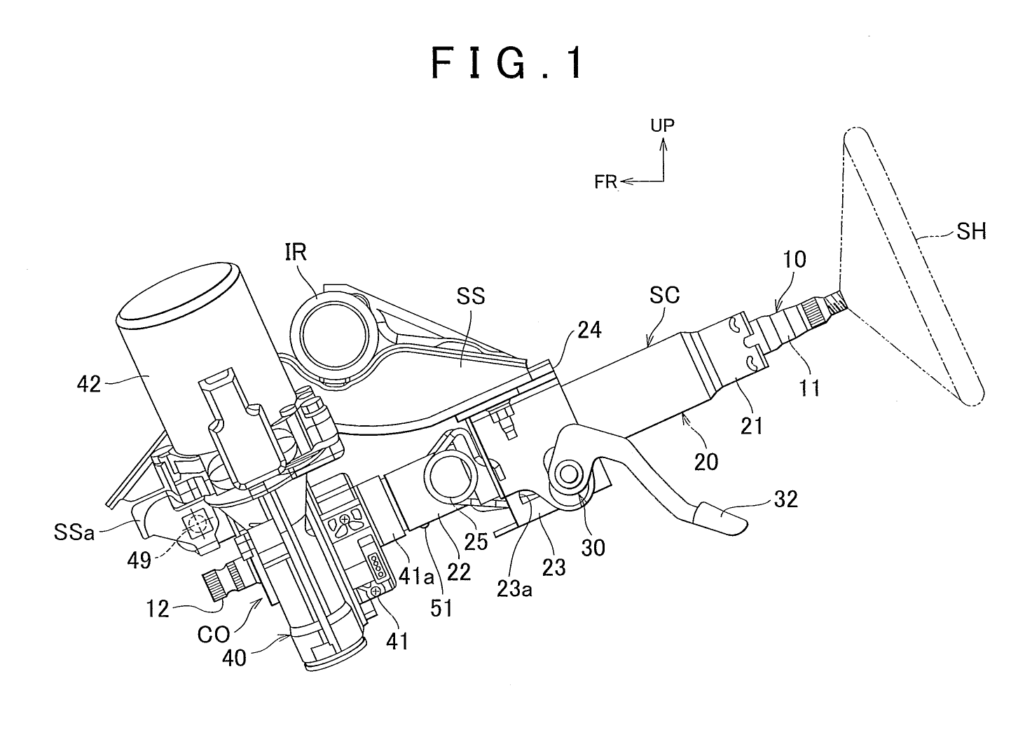

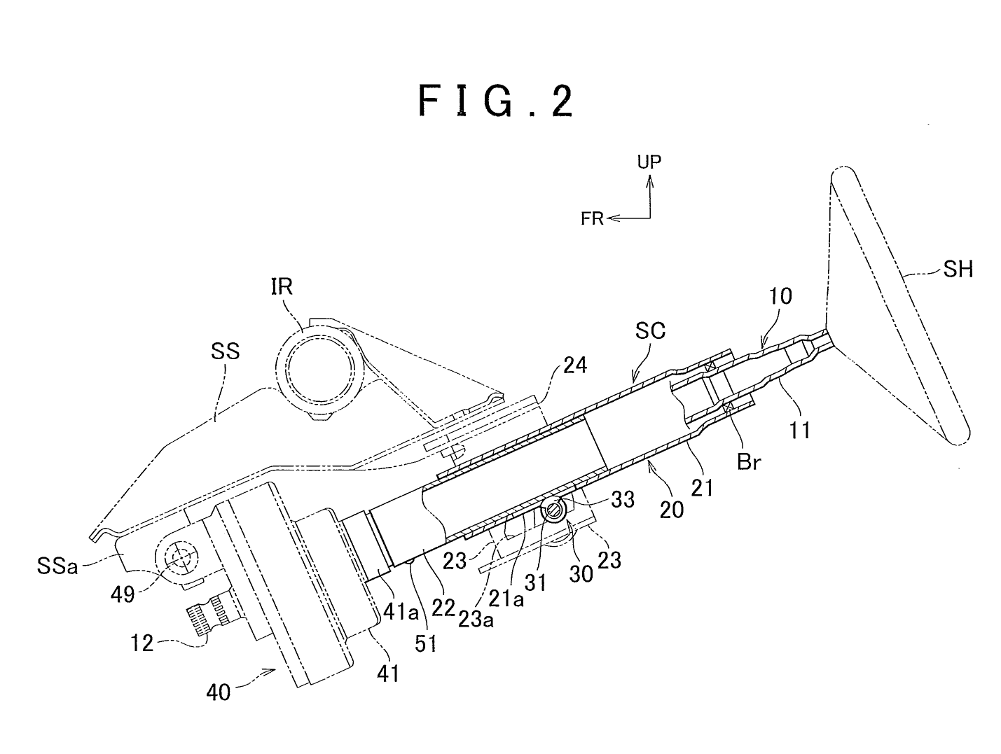

Hereinafter, each embodiment of the invention will be described with reference to the drawings. Each of FIG. 1 to FIG. 3 shows a steering column apparatus for a vehicle according to a first embodiment of the invention. In each of FIG. 1 and FIG. 2, the arrow “UP” indicates the top of a vehicle, and the arrow “FR” indicates the front side of the vehicle. As shown in FIG. 1, the steering column apparatus according to the first embodiment includes a steering wheel SH that functions as steering means rotated by a driver, and a transmission shaft (transmission mechanism) CO that connects the steering wheel SH to right and left front wheels (not shown) that function as steered wheels. The driver inputs a steering force to the steering wheel SH, and the steering wheel SH transmits the input steering force to the transmission shaft CO. The steering wheel SH is connected to an end portion of the transmission shaft CO, which is close to the driver.

The steering force is input to the transmission shaft CO through the steering wheel SH, and the transmission shaft CO transmits the input steering force to the right and left front wheels (not shown). The transmission shaft CO includes a steering main shaft 10 in a steering column SC; an intermediate shaft (not shown) connected to the steering main shaft 10 through an upper universal joint (not shown); a pinion shaft (not shown) connected to the intermediate shaft through a lower universal joint (not shown); a rack bar (not shown) connected to the pinion shaft through a pinion gear (not shown) and a rack gear (not shown); and a pair of right and left tie rods (not shown). The right and left tie rods are connected to respective right and left end portions of the rack bar through ball joints (not shown), and to knuckles (not shown), which are connected to the right and left front wheels, through ball joints (not shown). The configuration from the upper universal joint (not shown) to the right and left front wheels (not shown) is a known configuration.

The steering column SC holds the steering wheel SH in a manner such that the steering wheel is rotatable. The steering column SC includes the steering main shaft 10 that is rotatable integrally with the steering wheel SH; a column tube 20 that houses the steering main shaft 10, and supports the steering main shaft 10 in a manner such that the steering main shaft 10 is rotatable; a lock mechanism 30 that permits or restricts tilt operation of the steering column SC in upward and downward directions and telescopic operation of the steering column SC, in a direction of an axis of the steering column SC (hereinafter, referred to as “column axis direction”); and an electric power steering actuator (hereinafter, referred to as “EPS actuator”) 40 that functions as assist force providing means for providing a predetermined assist force for the operation of the steering wheel SH.

The steering main shaft 10 includes an upper shaft 11, a lower shaft (not shown), and an output shaft 12 connected to the lower shaft (not shown) through a torsion bar (not shown) in a manner such that torque can be transmitted. The upper shaft 11 is hollow. An upper end portion of the upper shaft 11 (i.e., the end portion of the upper shaft 11 close to the driver) is connected to the steering wheel SH. When the steering wheel SH is rotated, the upper shaft 11 is rotated integrally with the steering wheel SH. The lower shaft (not shown) is hollow. A lower end portion of the upper shaft 11 is inserted in the lower shaft in a manner such that the upper shaft 11 is slidable in the column axis direction, and torque can be transmitted.

As shown in FIG. 1 and FIG. 2, the column tube 20 supports the steering main shaft 10 in a manner such that the steering main shaft 10 is rotatable. The column tube 20 is supported to be inclined in a manner such that a front portion of the column tube 20 is at a position lower than a position of a rear portion of the column tube 20 in the vehicle, by a steering support member SS provided on an instrument panel reinforcement IR. The column tube 20 includes an upper tube 21 and a lower tube 22. The instrument panel reinforcement IR and the steering support member SS are vehicle body members fitted and fixed to a vehicle body.

As shown in FIG. 1 and FIG. 2, the upper tube 21 is connected to a breakaway bracket 24 connected to a rear bottom portion of the steering support member SS in the vehicle, in a manner such that the upper tube 21 is movable and adjustable in upward and downward directions and the column axis direction, through a lock mechanism 30, and a column bracket 23 that is integrally fixed to an outer periphery of a front bottom portion of the upper tube 21 in the vehicle. The lock mechanism 30 connects/disconnects the column bracket 23 to/from the breakaway bracket 24. That is, the lock mechanism 30 is placed in a locked state or an unlocked stated.

Thus, when the lock mechanism 30 is placed in the locked state, the column bracket 23 is fixed (connected) to the breakaway bracket 24 so that the column bracket 23 is immovable. When the lock mechanism 30 is placed in the unlocked state, the column bracket 23 is released from the breakaway bracket 24 so that the column bracket 23 is movable with respect to the breakaway bracket 24. As is generally known, the breakaway bracket 24 is connected to the rear bottom portion of the steering support member SS (i.e., a portion of the vehicle body) in the vehicle so that the breakaway bracket 24 is disconnected from the rear bottom portion of the steering support member SS, and moved toward the front side of the vehicle when a load equal to or above a predetermined value (i.e., a load toward the front side of the vehicle) is applied to the breakaway bracket 24.

As shown in FIG. 2, the upper tube 21 is hollow. The upper tube 21 supports the upper shaft 11 in a manner such that the upper shaft 11 is rotatable and movable in the column axis direction integrally with the upper tube 21, through a bearing Br that is integrally provided on an inner periphery of an upper end portion of the upper tube 21. In the upper tube 21, an insertion long hole 21a, which is long in the column axis direction, is formed. An eccentric cam 33 of the lock mechanism 30 is inserted through the insertion long hole 21a.

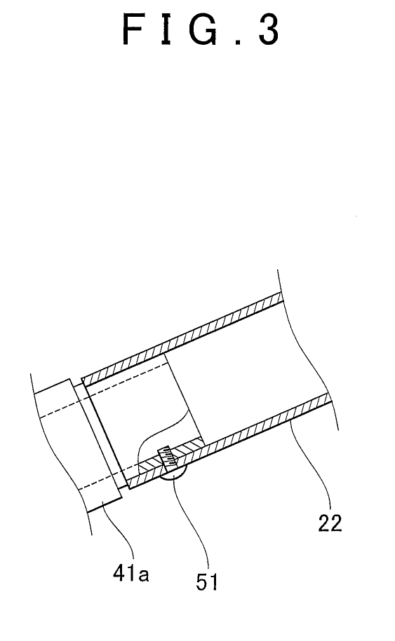

As shown in FIG. 1 and FIG. 2, the lower tube 22 is supported by a support bracket SSa that is fixed to a front bottom portion of the steering support member SS in the vehicle, through a housing 41 and a support pin 49 of the EPS actuator 40, in a manner such that the lower tube 22 is pivotable in the upward and downward directions (that is, the lower tube 22 is tiltable around an axis of the support pin 49 (a tilt center)). As shown in FIG. 2 and FIG. 3, the lower tube 22 is hollow. The lower tube 22 supports a lower shaft (not shown), through a bearing (not shown) that is integrally provided on an inner periphery of a lower end portion of the lower tube 22, in a manner such that the lower shaft is rotatable and immovable in the column axis direction. An upper end portion (i.e., a rear portion) of the lower tube 22 in the vehicle is inserted in a lower end portion (i.e., a front portion) of the upper tube 21 in the vehicle. Thus, the lower tube 22 supports the upper tube 21 in a manner such that the upper tube 21 is slidable in the column axis direction.

The lock mechanism 30 is a known lock mechanism. The lock mechanism 30 includes a shaft (bolt) 31, a nut (not shown), an operating lever 32, a lock cam unit, and the eccentric cam 33. The shaft (bolt) 31 extends in a lateral direction of the vehicle through a long hole (not shown) for tilt operation, which is formed in the breakaway bracket 24, and the long hole 23a (refer to FIG. 2) for telescopic operation, which is formed in the column bracket 23 to extend in the column axis direction. The long hole for tilt operation has an arc shape around the tilt center. The nut is fitted to a right end portion of the shaft 31 in the vehicle. The operating lever 32 is fitted to a left end portion of the shaft 31 in the vehicle in manner such that the operating lever 32 is rotatable integrally with the shaft 31. The lock cam unit is fitted to the shaft 31 at a position between the breakaway bracket 24 and the operating lever 32. The eccentric cam 33 is fitted to an outer periphery of an intermediate portion of the shaft 31 in a manner such that the eccentric cam 33 is rotatable integrally with the shaft 31.

When the operating lever 32 is rotated in a counterclockwise direction in FIG. 1, the lock cam unit (not shown) increases a frictional engagement force between the breakaway bracket 24 and the column bracket 23. When the operating lever 32 is rotated in a clockwise direction in FIG. 1, the lock cam unit decreases the frictional engagement force between the breakaway bracket 24 and the column bracket 23. When the shaft 31 is rotated in the counterclockwise direction in FIG. 1 due to the rotation of the operating lever 32 in the counterclockwise direction in FIG. 1, the eccentric cam 33 engages with an outer periphery of a bottom portion of the lower tube 22. When the shaft 31 is rotated in the clockwise direction in FIG. 1 due to the rotation of the operating lever 32 in the clockwise direction in FIG. 1, the eccentric cam 33 disengages from the outer periphery of the bottom portion of the lower tube 22.

Thus, when the operating lever 32 is rotated in the counterclockwise direction in FIG. 1 to a lock position, the lock mechanism 30 is placed in the locked state. This restricts the tilt operation of the steering column SC (that is, the tilt movement of the steering column SC around the axis of the support pin 49 (the tilt center)), and the telescopic operation of the steering column SC (the movement of the upper shaft 11 and the upper tube 21 in the column axial direction with respect to the lower shaft and the lower tube 22). When the operating lever 32 is rotated in the clockwise direction in FIG. 1 to an unlock position, the lock mechanism 30 is placed in the unlocked state. This permits the tilt operation and the telescopic operation of the steering column SC. When the lock mechanism 30 is in the unlocked state, a spring 25, which is provided between the breakaway bracket 24 and the shaft 31, resiliently restricts the downward movement of the steering column SC.

The EPS actuator 40 provides assist torque (an assist force) to the output shaft 12 of the steering main shaft 10, to reduce steering torque that is input to the steering wheel SH when the driver rotates the steering wheel SH. As shown in FIG. 1 to FIG. 3, the EPS actuator 40 includes the housing 41, an electric motor 42, and a reducer (not shown). The housing 41 is integrally connected to the lower end portion (i.e., the front end portion) of the lower tube 22 in the vehicle by fitting the housing 41 into the lower end portion of the lower tube 22. The electric motor 42 is fitted to the housing 41. The reducer is provided in the housing 41 to reduce an output from the electric motor 42.

An output shaft of the electric motor 42 is connected to the output shaft 12 of the steering main shaft 10 through the reducer in a manner such that torque can be transmitted. The electric motor 42 is rotated by controlling supply of electric power to the electric motor 42 according to a torsion amount of a torsion bar (not shown) provided between the lower shaft (not shown) and the output shaft 12 in the steering main shaft 10 (i.e., according to the steering torque detected by a torque sensor (not shown)). Thus, the electric motor 42 provides the assist torque to the output shaft 12 of the steering main shaft 10 according to the steering torque.

In the first embodiment, a screw 51 is provided only in a bottom portion of a fitting portion where a lower-tube support cylindrical portion of the housing 41 of the EPS actuator 40, that is, a rear end portion 41a of the housing 41 in a longitudinal direction of the vehicle is fitted into the lower end portion (the front end portion) of the lower tube 22 in the vehicle, in a manner such that the rear end portion 41a of the housing 41 is integrated with the lower end portion of the lower tube 22. That is, the screw 51 is provided only in the bottom portion of an area where the rear end portion 41 of the housing 41 is integrated with the lower end portion of the lower tube 22. The screw 51 restricts the movement of the rear end portion 41a of the housing 41 and the lower end portion of the lower tube 22 away from each other. Thus, the screw 51 increases connection strength of only the bottom portion of the fitting portion where the rear end portion 41a of the housing 41 is fitted into the lower end portion of the lower tube 22.

In the first embodiment with the above-described configuration, the breakaway bracket 24 is at a set position with respect to the steering support member SS, and the steering column SC is appropriately supported by the steering support member SS, at a normal time (i.e., when a vehicle collision does not occur). Also, in the first embodiment, when the driver collides with the steering wheel SH, and the breakaway bracket 24 receives a load (a secondary collision load) toward the front side of the vehicle, which is equal to or above a predetermined value, at a time of a vehicle collision, the breakaway bracket 24 is disconnected from the steering support member SS, and the breakaway bracket 24 is moved from the set position toward the front side of the vehicle.

At this time (when the breakaway bracket 24 is moved from the set position toward the front side of the vehicle), a bending moment occurs in the fitting portion where the rear end portion 41a of the housing 41 is fitted into the lower end portion of the lower tube 22, due to the secondary collision load. As a result, the rear end portion 41a of the housing 41 pivots downward around the tilt center of the housing 41, and the lower end portion of the lower tube 22 pivots downward so that the lower end portion of the lower tube 22 is disconnected from the rear end portion 41a of the housing 41.

However, in the above-described first embodiment, the screw 51 is provided only in the bottom portion of the area where the rear end portion 41a of the housing 41 is integrated with the lower end portion of the lower tube 22. The portion where the screw 51 is provided (i.e., the bottom portion of the above-described fitting portion) is pulled due to the bending moment, and is more likely to be displaced and deformed than a top portion of the fitting portion (i.e., the portion compressed due to the bending moment), when a secondary collision occurs at a time of a vehicle collision. Accordingly, in the first embodiment, displacement and deformation due to the bending moment are made less likely to occur by the screw 51 provided only in the bottom portion of the fitting portion, and the weight is reduced as compared to the case where the entire fitting portion is reinforced. As a result, it is possible to effectively suppress the displacement and deformation of the lower end portion of the lower tube 22. Thus, the upper tube 21 is appropriately moved in the column axis direction with respect to the lower tube 22.

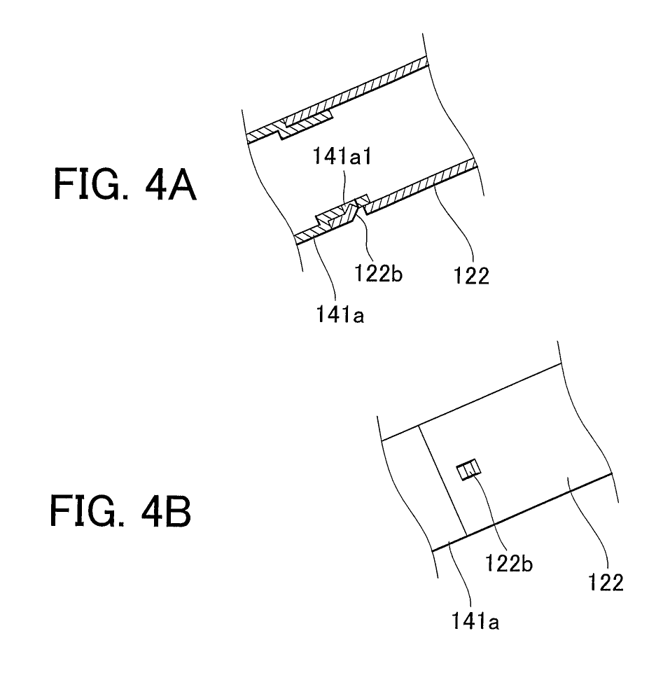

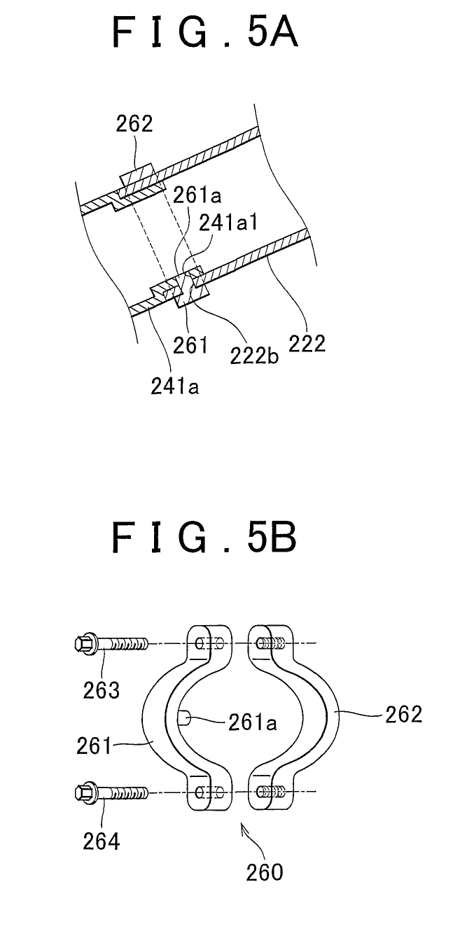

In the above-described first embodiment, only the bottom portion of the area where the rear end portion 41a of the housing 41 is integrated with the lower end portion of the lower tube 22 (i.e., the bottom portion of the fitting portion) is reinforced by the screw 51. However, only the bottom portion of the area where the rear end portion 41a of the housing 41 is integrated with the lower end portion of the lower tube 22 may be reinforced by a hook 122b in a second embodiment shown in FIGS. 4A and 4B, or by a pin 261a in a third embodiment shown in FIGS. 5A and 5B.

The hook 122b in the second embodiment shown in FIGS. 4A and 4B is formed by cutting a portion of the bottom portion of the lower end portion of a lower tube 122 in a U-shape. The hook 122b is pressed into an engagement hole 141a1 formed in a rear end portion 141a. Thus, the hook 122b restricts the movement of the rear end portion 141a of the housing and the lower end, portion of the lower tube 122 away from each other. In the second embodiment, the displacement and deformation due to the bending moment are made less likely to occur by the hook 122b provided only in the bottom portion of the fitting portion, and the weight is reduced.

The pin 261a in the third embodiment shown in FIG. 5 is integrally formed in a lower semicircular ring 261 of a retention ring 260. The pin 261a is fitted into a through-hole 222b formed in the bottom portion of the lower end portion of a lower tube 222, and a through-hole 241a1 formed in a bottom portion of a rear end portion 241a of the housing. Thus, the pin 261a restricts the movement of the rear end portion 241a of the housing and the lower end portion of the lower tube 222 away from each other. The retention ring 260 is removably fitted to the outer periphery of the lower end portion of the lower tube 222. The retention ring 260 includes the lower semicircular ring 261, an upper semicircular ring 262, and a pair of bolts 263 and 264 that connects the lower semicircular ring 261 to the upper semicircular ring 262. In the third embodiment, the displacement and deformation due to the bending moment are made less likely to occur by the pin 261a provided only in the bottom portion of the fitting portion.

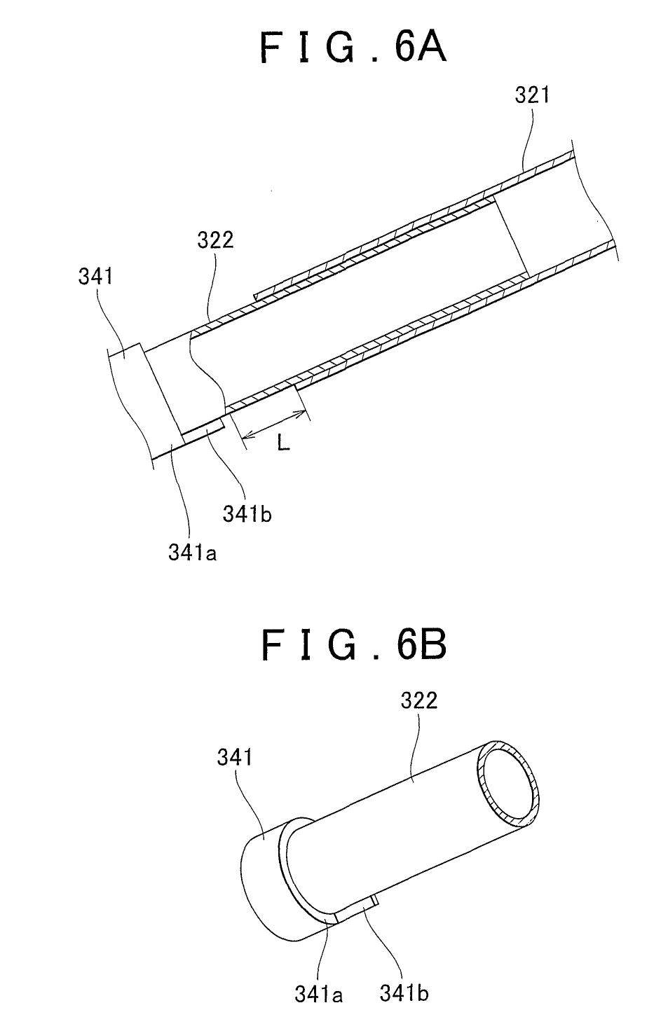

In the first embodiment to the third embodiment, the rear end portion of the housing and the lower end portion of the lower tube are constituted by separate members. However, as in a fourth embodiment shown in FIG. 6, a rear end portion 341a of a housing 341 may be integrated with a lower end portion of a lower tube 322 by integrally forming the housing 341 and the lower tube 322.

In the fourth embodiment, a reinforcement rib 341b, which functions as the reinforcement portion, is integrally formed only in the bottom portion of the area where the rear end portion 341a of the housing 341 is, integrated with the lower end portion of the lower tube 322. The reinforcement rib 341b extends in the column axis direction. A length of the reinforcement rib 341b in the column axis direction is set so that the upper tube 321 is movable a predetermined distance L. Thus, in the forth embodiment, the deformation due to the bending moment is made less likely to occur by the reinforcement rib 341b, and the weight is reduced.

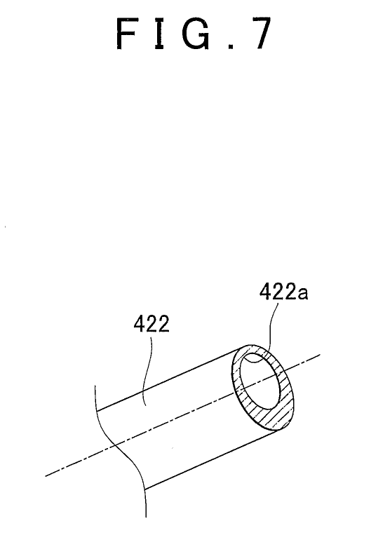

In the fourth embodiment, the reinforcement rib 341b is provided only in the bottom portion of the area where the rear end portion 341a of the housing 341 is integrated with the lower end portion of the lower tube 322. However, a configuration in a fifth embodiment shown in FIG. 7 may be made. In the fifth embodiment shown in FIG. 7, the rear end portion of the housing is integrated with the lower end portion of the lower tube by integrally forming the housing and the lower tube.

Also, in the fifth embodiment shown in FIG. 7, a center of an inner hole 422a formed in a lower tube 422 (i.e., an axial center of the steering shaft) is offset upward from an axis of the lower tube 422 by a predetermined amount in a direction perpendicular to the axis of the lower tube 422. Accordingly, the reinforcement portion (thick portion) is formed only in the bottom portion of the area where the rear end portion of the housing is integrated with the lower end portion of the lower tube 422. Thus, in the fifth embodiment, the deformation due to the bending moment is made less likely to occur by the reinforcement portion (thick portion), and the weight is reduced. In each of the above-described embodiments, the rear end portion of the housing is integrated with the lower end portion of the lower tube by fitting the rear end portion of the housing into the lower end portion of the lower tube. However, the rear end portion of the housing may be integrated with the lower end portion of the lower tube by fitting the lower end portion of the lower tube into the rear end portion of the housing. In each of the above-described embodiments, the reinforcement portion is provided only in the bottom portion of the area where the rear end portion of the housing is integrated with the lower end portion of the lower tube. However, the reinforcement portion(s) may be provided in one ore more other locations, in addition to the reinforcement portion provided in the bottom portion of the area where the rear end portion of the housing is integrated with the lower end portion of the lower tube.

While the invention has been described with reference to example embodiments thereof, it is to be understood that the invention is not limited to the described embodiments or constructions. To the contrary, the invention is intended to cover various modifications and equivalent arrangements. In addition, while the various elements of the example embodiments are shown in various combinations and configurations, other combinations and configurations, including more, less or only a single element, are also within the spirit and scope of the invention.

1. A steering column apparatus for a vehicle, comprising:
a steering column that holds a steering wheel in a manner such that the steering wheel is rotatable, the steering column including:
a housing of a power steering actuator, which is tiltable in upward and downward directions with respect to a portion of a vehicle body;
a lower tube connected to the portion of the vehicle body through the housing, wherein a rear end portion of the housing in a longitudinal direction of a vehicle is integrated with a lower end portion of the lower tube;
an upper tube connected to the lower tube to be slidable in a direction of an axis of the steering column, wherein the upper tube is telescopic, the upper tube is connected to the portion of the vehicle body through a bracket, and the upper tube is moved toward a front side of the vehicle with respect to the portion of the vehicle body when a load equal to or above a predetermined value is applied to the upper tube; and
a reinforcement portion provided only in a bottom portion of an area where the rear end portion of the housing is integrated with the lower end portion of the lower tube.

2. The steering column apparatus according to claim 1, wherein:
the rear end portion of the housing is integrated with the lower end portion of the lower tube by fitting the rear end portion of the housing to the lower end portion of the lower tube; and
the reinforcement portion restricts movement of the rear end portion of the housing and the lower end portion of the lower tube away from each other.

3. The steering column apparatus according to claim 2, wherein:
the rear end portion of the housing is integrated with the lower end portion of the lower tube by fitting the rear end portion of the housing into the lower end portion of the lower tube; and
the reinforcement portion is configured using a screw.

4. The steering column apparatus according to claim 2, wherein:
the rear end portion of the housing is integrated with the lower end portion of the lower tube by fitting the lower end portion of the lower tube into the rear end portion of the housing; and
the reinforcement portion is configured using a screw.

5. The steering column apparatus according to claim 2, wherein:
the rear end portion of the housing is integrated with the lower end portion of the lower tube by fitting the rear end portion of the housing into the lower end portion of the lower tube; and
the reinforcement portion is configured using a hook formed in a bottom portion of the lower end portion of the lower tube, and the hook is pressed into an engagement hole formed in the rear end portion of the housing.

6. The steering column apparatus according to claim 2, further comprising
a retention ring removably fitted to an outer periphery of the lower end portion of the lower tube,
wherein:
the rear end portion of the housing is integrated with the lower end portion of the lower tube by fitting the rear end portion of the housing into the lower end portion of the lower tube; and
the reinforcement portion is configured using a pin that is integrally formed in a lower portion of the retention ring, and the pin is fitted into a through-hole formed in a bottom portion of the lower end portion of the lower tube, and a through-hole formed in a bottom portion of the rear end portion of the housing.

7. The steering column apparatus according to claim 6, wherein:
the retention ring includes a lower semicircular ring, an upper semicircular ring, and a pair of bolts that connects the lower semicircular ring to the upper semicircular ring; and
the pin is integrally formed in the lower semicircular ring.

8. The steering column apparatus according to claim 1, wherein:
the rear end portion of the housing is integrated with the lower end portion of the lower tube by integrally forming the housing and the lower tube; and
the reinforcement portion is configured using a reinforcement rib that extends in the direction of the axis of the steering column.

9. The steering column apparatus according to claim 8, wherein
a length of the reinforcement rib in the direction of the axis of the steering column is set so that the upper tube is movable a predetermined distance.

10. The steering column apparatus for a vehicle according to claim 1, wherein:
the rear end portion of the housing is integrated with the lower end portion of the lower tube by integrally forming the housing and the lower tube; and
the reinforcement portion is formed by forming an inner hole of the lower tube in a manner such that a center of the inner hole is offset upward from an axis of the lower tube by a predetermined amount in a direction perpendicular to the axis of the lower tube.

11. A steering column apparatus for a vehicle, comprising:
a steering column that holds a steering wheel in a manner such that the steering wheel is rotatable, the steering column including:
a housing of a power steering actuator, which is tiltable in upward and downward directions with respect to a portion of a vehicle body;
a lower tube connected to the portion of the vehicle body through the housing, wherein a rear end portion of the housing in a longitudinal direction of a vehicle is integrated with a lower end portion of the lower tube;
an upper tube connected to the lower tube to be slidable in a direction of an axis of the steering column, wherein the upper tube is telescopic, the upper tube is connected to the portion of the vehicle body through a bracket, and the upper tube is moved toward a front side of the vehicle with respect to the portion of the vehicle body when a load equal to or above a predetermined value is applied to the upper tube; and
a reinforcement portion provided in a bottom portion of an area where the rear end portion of the housing is integrated with the lower end portion of the lower tube.
